(19) United States
(12) Patent Application Publication
(10) Pub. No.: US 2014/0258989 A1
(43) Pub. Date: Sep. 11, 2014

(54) METHOD AND SYSTEM FOR AUTOMATING A SCENE-BASED TEST

(71) Applicant: Ilyong Moon, Seoul (KR)

(72) Inventor: Ilyong Moon, Seoul (KR)

(73) Assignee: ONYCOM, INC., Seoul (KR)

(21) Appl. No.: 14/350,796

(22) PCT Filed: Oct. 26, 2011
(86) PCT No.: PCT/KR2011/008004

§ 371 Date: Apr. 9, 2014

(30) Foreign Application Priority Data
Oct. 10, 2011 (KR) 10-2011-0103052

(51) Int. Cl. G06F 11/36

(52) U.S. Cl. CPC G06F 11/3688
USPC 717/127

(57) ABSTRACT

There are provided a method and a system for automating a scene-based test. The method for automating a scene-based test that is performed by a system for automating a scene-based test, and the method includes a preparing step of preparing a scene scenario that includes at least two or more program scenes—images constituting a screen of a testing target device on which a program to be tested is executed or a set of the images—and an event object linking the program scenes, an executing step of interpreting the scene scenario in a time-series manner to execute the scene scenario, and transmitting an event signal corresponding to the event object to the testing target device linked to the system via communication when the event object is executed, and a result generating step of receiving a program execution log from the testing target device, and generating a test result.

### TECHNICAL FIELD

The present invention relates to a method and a system for automating a scene-based test, and more particularly, to a method and a system that design flow of a user interface or verify developed software by automatically testing software by a scenario.

### BACKGROUND ART

A process of verifying and testing software developed in a software develop life cycle of the software is very important. This process includes a process of finding a lurking bug that does not exposed to the outside, and a process of checking whether or not flow of a user interface is actually operated by a scenario as intended and designed. Particularly, in many cases, the user interface is implemented as a user friendly GUI (Graphic User Interface), and since software use experience of a user is also focused on convenience of the GUI, a test for the user interface becomes more important.

Various means are proposed as a system for testing software, but most of them create a test script, and execute the creased test script to generate an executed result (“Test cases generation method for GUT testing with automatic scenario generation,” Journal article, Chungnam National University, and Korean Registered Patent No. 10-1014679). However, in such a method, there is an inconvenience that a user needs to directly create a test script suitable for grammar. Further, since the test script needs to be interpreted and analyzed, it may be difficult to perform maintenance, and since the test script is not intuitive, it may be difficult for anyone to easily check and use the entire test scenario.

### DETAILED DESCRIPTION

### Technical Problem

An object of the present invention is to provide a method and a system capable of intuitively and easily automating a test based on an event and a scene serving as an actual program execution screen.

An object of the present invention is to also provide a method and a system capable of interactively designing, checking and verifying flow of a user interface of a program.

An object of the present invention is to also provide a convenient and intuitive method and a system for automating a test by extracting an automation scenario of a scene-based test from a behavior of executing and using a program.

### Technical Solution

In order to achieve the above object, an embodiment of the present invention provides a method for automating a scene-based test that is performed by a system for automating a scene-based test. The method includes a preparing step of preparing a scene scenario that includes at least two or more program scenes—images constituting a screen of a testing target device on which a program to be tested is executed or a set of the images—and an event object linking the program scenes, an executing step of interpreting the scene scenario in a time-series manner to execute the scene scenario, and transmitting an event signal corresponding to the event object to the testing target device linked to the system via communication when the event object is executed, and a result generating step of receiving a program execution log from the testing target device, and generating a test result.

The preparing step may include a step of receiving at least two or more program scenes and event data occurring between the program scenes from the testing target device on which the program to be tested is executed, and a step of creating the scene scenario by linking the received program scenes and the event objects corresponding to the event data in a time-series manner.

The preparing step may further include a step of receiving input of a user to edit the event and the program scene constituting the scene scenario.

The event object further may include a programming object for linking an arbitrary program scene depending on a result of analyzing the program execution log, and in the executing step, when the event object to be executed is the programming object, the program execution log received from the testing target device may be analyzed, and a linked program scene may be executed depending on an analyzed result.

The scene scenario may further include a time synchronization value, and in the executing step, the scene scenario may be interpreted in a time-series manner by referring to the time synchronization value to be executed.

The event object my include a component identification value for generating an event and a kind of the event, and the event signal may include the component identification value for generating the event and the kind of the event.

The program execution log may include execution scene data on which the program to be tested is executed on the testing target device, and in the result generating step, the execution scene data received from the testing target device and the program scene being currently executed may be compared with each other to generate the test result.

In the executing step, the program scene being currently executed or the event object may be displayed to the outside through a display unit.

Another embodiment of the present invention provides a system for automating a scene-based test. The system includes a communication unit that is linked to a testing target device via communication, a scene scenario managing unit that stores a scene scenario including at least two or more program scenes—images constituting a screen of the testing target device on which a program to be tested is executed or a set of the images—and event objects linking the program scenes, a test executing unit that analyzes the scene scenario in a time-series manner to execute the scene scenario, and transmits an event signal corresponding to the event object to the testing target device through the communication unit when the event object is executed, and a test analyzing unit that receives a program execution log from the testing target device to generate a test result.

### Effect of the Invention

According to an embodiment of the present invention, it is possible to provide a method and a system capable of intuitively and easily automating a test based on an event and a scene serving as an actual program execution screen.

Further, according to the embodiment of the present invention, it is possible to provide a method and a system capable of interactively designing, checking and verifying flow of a user interface of a program.

Furthermore, according to the embodiment of the present invention, it is possible to provide a convenient and intuitive method and a system for automating a test by extracting an automation scenario of a scene-based test from a behavior of executing and using a program.

### BRIEF DESCRIPTION OF DRAWINGS

FIG. 1 is a block diagram illustrating a system for automating a test according to the present invention.

FIG. 2 is a diagram illustrating a state where a testing target device and the system for automating a test according to the present invention are linked together.

FIG. 3 is a flowchart illustrating a method for automating a scene-based test according to the present invention.

FIG. 4 is a diagram illustrating a scene scenario according to the present invention.

FIG. 5 is a diagram illustrating various event objects included in the scene scenario according to the present invention.

FIG. 6 is a diagram illustrating examples of components constituting the screen of the testing target device.

### EMBODIMENTS OF THE INVENTION

Hereinafter, a method and a system for automating a scene-based test according to embodiments of the present invention will be described in detail with reference to the drawings. Merits and characteristics of the present invention, and methods for accomplishing them will become more apparent from the following embodiments taken in conjunction with the accompanying drawings.

The present invention is not limited to the embodiments disclosed herein, and the embodiments may be implemented in various forms. The embodiments are provided to complete the disclosure of the present invention and to allow those having ordinary skill in the art to understand the scope of the present invention. The present invention is defined by the category of the claims.

The same reference numerals will be used throughout the specification to refer to the same parts.

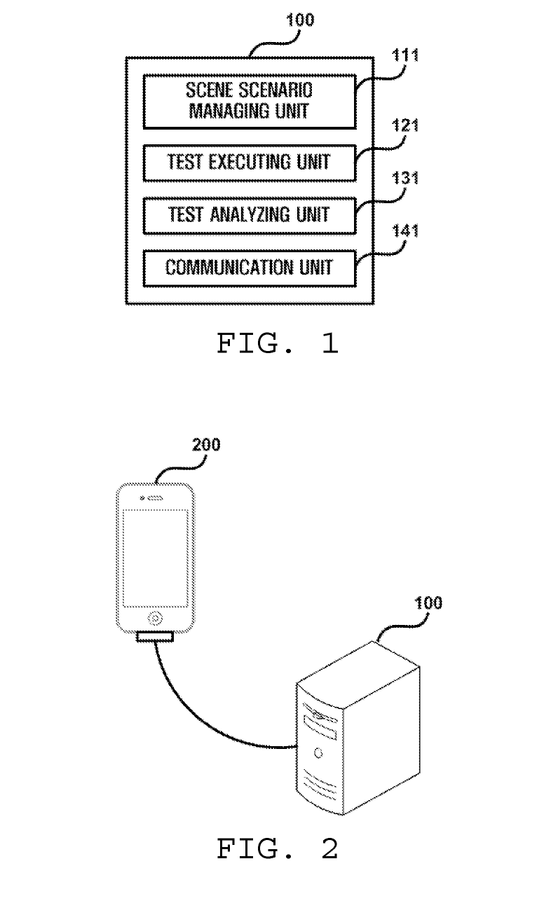

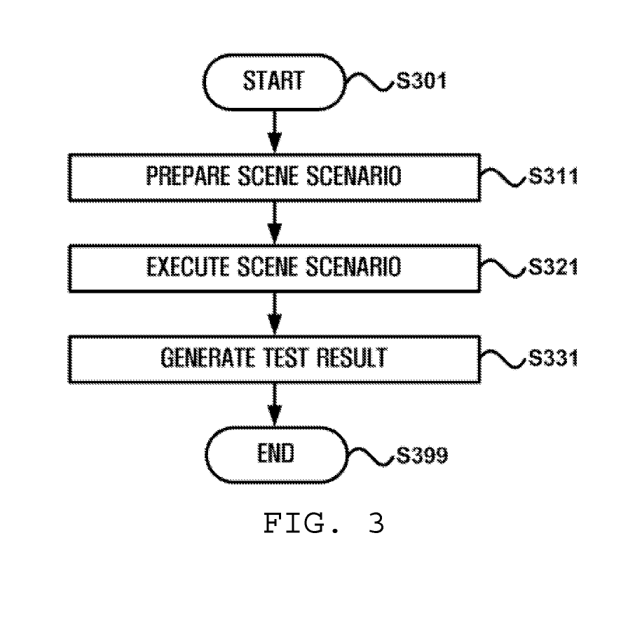

FIG. 1 is a block diagram illustrating a system for automating a test according to the present invention, and FIG. 2 is a diagram illustrating a state where a testing target device and the system for automating a test according to the present invention are linked together. A system for automating a scene-based test 100 according to the present invention is linked to an external testing target device 200 via communication to test the device. The external testing target device 200 is a device on which a program to be tested is installed and executed, and includes all electronic devices, such as a PC (Personal Computer), a notebook computer, a smartphone and a tablet PC, which can perform information processing. The system for automating a scene-based test 100 and the testing target device 200 may be linked together via all communication means, such as cable communication and radio communication, which can perform electronic data interchange. The system for automating a scene-based test 100 includes a scene scenario managing unit 111 that manages a scene scenario, a test executing unit 121, a test analyzing unit 131, and a communication unit 141. The respective units may be implemented as hardware or software module for operating the hardware, and functions and roles thereof will be described below.

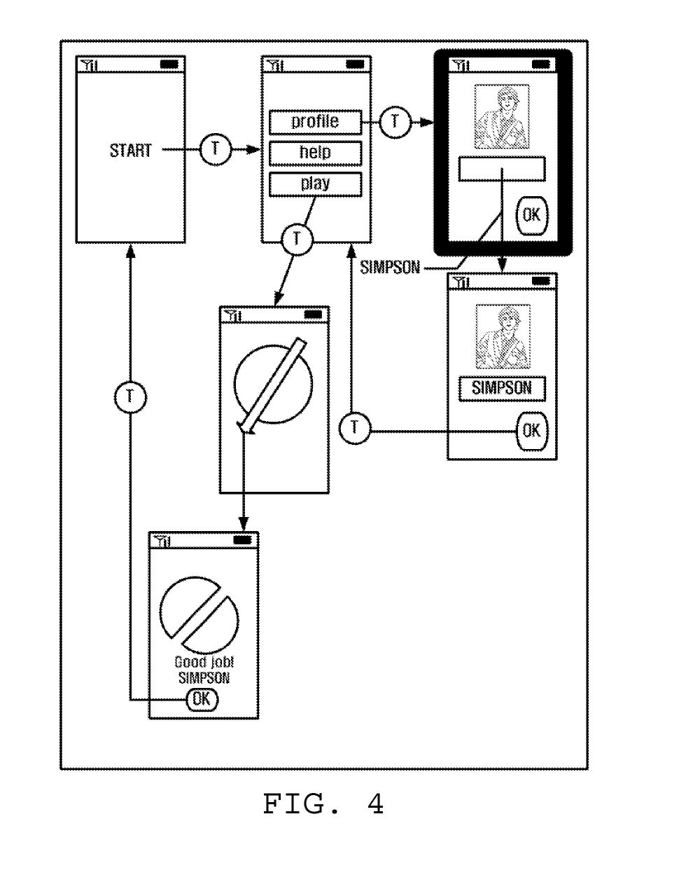

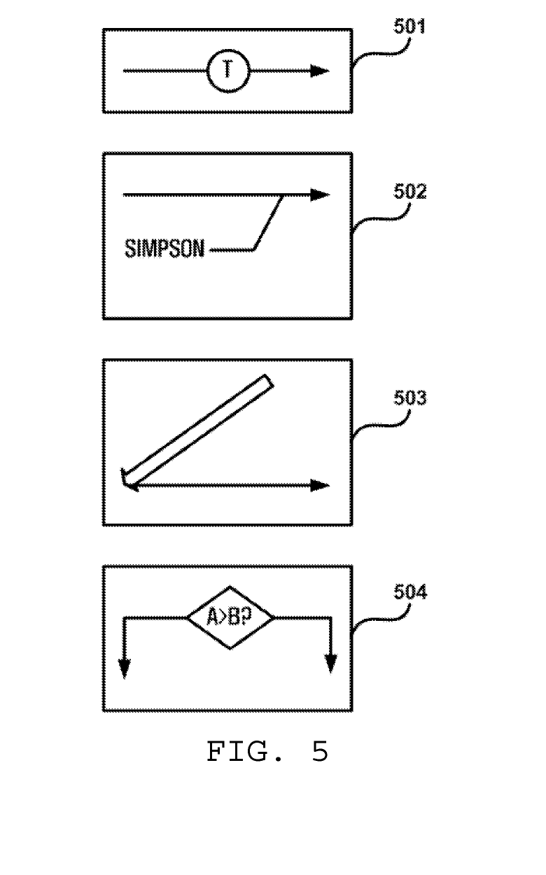

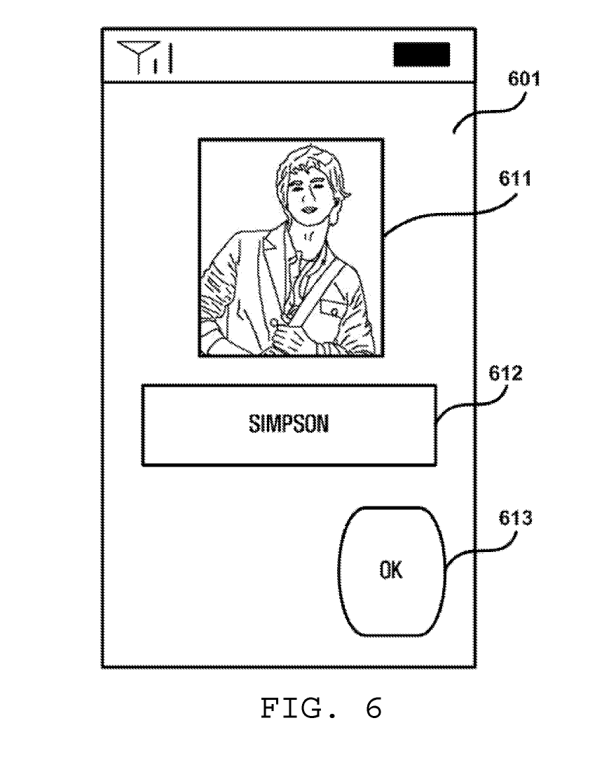

FIG. 3 is a flowchart illustrating a method for automating a scene-based test according to the present invention. Before the test is performed, the communication unit 141 of the system for automating a scene-based test 100 and the testing target device 200 need to be linked together via communication. The scene scenario managing unit 111 stores a scene scenario, and the scene scenario includes at least two or more program scenes and a set of event objects linking the respective program scenes. The program scene means data obtained by recording a screen on which the program to be tested is executed, and may be implemented as images such as a kind of screenshots or a set of the images. FIG. 4 is a diagram for describing an example of the scene scenario according to the present invention. An example of the program to be tested may include a game in which when a user drags an arbitrary displayed figure on a touch panel to generate a trace, the user fulfils a mission that equally divides the figure by the trace. As illustrating in the drawing, when a game program is started, a screen on which a “START” button is shown, and when the button is touched, a screen on which “profile,” “help,” and “play” buttons are shown is displayed. It is assumed that a gamer can input his or her profile information by clicking the “profile” button, the gamer can check an explanation of the game by clicking the “help” button, the gamer can start the game by clicking the “play” button, and an initial screen is displayed when a mission of the game is completed. In the drawing, six program scenes are images of screenshots of program execution screens constituting a scenario. Various event objects are used to link these scenes. The event object means an expression object expressed by schematizing an event, such as user's input, which triggers scenario progress in a test scenario (a scene scenario). Examples of the various event objects are illustrated in FIG. 5, and may include a touch event 501 indicating that the user touches a start point of an arrow, a keypad event 502 indicating that the user inputs a portion where the start point of the arrow is positioned through a keypad, a drag event 503 indicating that the user drags from a start point to an end point of an empty arrow, and a programming object 504 branched by checking whether or not an arbitrary programmed trigger condition is satisfied. Various types of event objects may be defined and used (ends of the arrows in the event objects indicate a program scene to be subsequently executed).

Accordingly, when the scene scenario of FIG. 4 is interpreted again, when the game is started, the “START” button is displayed in a center of the screen, and when the button is touched, a program scene on which three buttons of “profile,” “help,” and “play” are shown is displayed. Subsequently, when the “profile” button is touched, a program scene for setting a gamer's photo and a gamer's name is displayed. At this time, after “SIMPSON” is input in a text box for setting the gamer's name through the keypad, when an “OK” button is touched, a program scene on which the three buttons of “profile,” “help”, and “play” are shown is displayed back. When the “play” button is touched, a game screen on which a circle is shown in a center of a screen is displayed. At this time, when an event that equally divides the circle through dragging occurs, a program scene on which objects created by equally dividing the circle by the trace of the dragging, a text object of “Good job! SIMPSON,” and a button object of “OK” are shown is displayed. When the “OK” button is touched, the initial screen is displayed again.

The scene scenario is stored in the scene scenario managing unit 111, and the user may edit, add, or delete the program scenes or the event objects by providing an WYSIWYG (what you see is what you get) editing function to the user. Furthermore, the scene scenario managing unit 111 receives the program scenes and event data in order of time through the communication unit 141 from the testing target device on which the program to be tested is actually executed, and interprets and analyzes the received program scenes and event data to automatically create the scene scenario including the program scenes and a set of event objects corresponding to the event data. At this time, the event data means an electric signal indicating a kind of an occurred event or a position (coordinates or the like) of the occurred event.

Moreover, the scene scenario may further include a time synchronization value. For example, the time synchronization value may be a time value for which the program scene is displayed before the next event object is executed. Accordingly, a displaying time of the executed scene scenario may be appropriately adjusted, and a variation of the screen with time may be used as a testing target. The time synchronization value may be edited by the user by using the editing function provided by the scene scenario managing unit 111, and the time synchronization value may be automatically included in the scene scenario by receiving time information and then interpreting and analyzing the received time information at the same time when the scene scenario is automatically created by receiving the program scenes and the event data from the testing target device on which the program is actually executed and then interpreting and analyzing the received program scenes and event data.

In this way, when the scene scenario is prepared (S311), the test executing unit 121 interprets the scene scenario in a time-series manner to execute the scene scenario (S321). The executing of the scene scenario may be controlled by the time synchronization value. When the event object is executed, an event signal (an electric signal for generating the event) corresponding to the event object is transmitted to the testing target device linked to the system via communication, so that the event corresponding to the event signal actually occurs on the testing target device 200. At this time, as illustrated in FIG. 4, the program scene or event object that is currently being executed is emphasized in the scene scenario displayed through a display unit to the outside, so that a progress status of the scene scenario can be checked.

The test analyzing unit 131 receives a program execution log from the testing target device 200, and generates a test result (S331). The program execution log means all data of result values obtained by executing the program to be tested, and may be execution scene data (screenshots) of the program being actually executed, or may be a trace value output through a consol. When the test analyzing unit 131 analyzes the execution scene data, the test result may be generated by comparing whether or not a part or all of the execution scene data is the same as the program scene being currently executed in the scene scenario and checking whether or not the test result is normal or abnormal, or may be generated by parsing the trace value.

The program execution log received from the testing target device 200 through the communication unit 141 during executing of the scene scenario may be used for the programming object branched so as to execute other types of scenarios depending on the result value. For example, when the event object is the program execution log, the scene scenario may be designed such that the program execution log is analyzed to analyze a value included in the trace value, so that the program scene being executed is branched into other program scenes depending on the analyzed result value.

The event object may be implemented by including a kind of the event and coordinates where the event occurs, but may be implemented based on handles (identification values) of components where the event occurs. As illustrated in FIG. 6, any one GUI screen includes various components such as an image component 611, a text input component 612 and a button component 613 on a background component 601. In this case, each component internally has a unique handle (an identification value), and, thus, when the component is used to record an occurrence of the event and generate the event, even more elaborate control can be performed, and the scenario can be efficiently stored. In this case, the event object needs to include information on the component identification value and the kind of the event.

It will be understood by those skilled in the art that the embodiments of the present invention can be implemented in other concrete forms without departing from the essential feature and spirit of the present invention. Therefore, it should be understood that the embodiments described above are examples in all aspects and not restrictive. The scope of the present invention is defined by the claims other than the detailed description, and all modifications and variations derived from the meaning and scope of the claims and their equivalents should be interpreted as fall in the scope of the invention.

1. A method for automating a scene-based test that is performed by a system for automating a scene-based test, the method comprising:
a preparing step of preparing a scene scenario that includes at least two or more program scenes and an event object;
an executing step of interpreting the scene scenario in a time-series manner to execute the scene scenario, and transmitting an event signal corresponding to the event object to the testing target device linked to the system via communication when the event object is executed; and
a result generating step of receiving a program execution log from the testing target device, and generating a test result,
wherein in the executing step, the program scene being currently executed or the event object are emphasized in the scene scenario displayed to the outside through a display unit,
wherein the scene scenario comprises the image constituting a screen of a testing target device on which a program to be tested is executed or a set of the images,
and wherein the event object comprises an expression object expressed by schematizing an event progressing scenario by linking at least two or more program scenes.

2. The method for automating a scene-based test according to claim 1, wherein the preparing step includes a step of receiving at least two or more program scenes and event data occurring between the program scenes from the testing target device on which the program to be tested is executed; and a step of creating the scene scenario by linking the received program scenes and the event objects corresponding to the event data in a time-series manner.

3. The method for automating a scene-based test according to claim 1, wherein the preparing step further includes a step of receiving input of a user to edit the event object and the program scene constituting the scene scenario.

4. The method for automating a scene-based test according to claim 3, wherein the event object further includes a programming object for linking an arbitrary program scene depending on a result of analyzing the program execution log, and in the executing step, when the event object to be executed is the programming object, the program execution log received from the testing target device is analyzed, and a linked program scene is executed depending on an analyzed result.

5. The method for automating a scene-based test according to claim 1, wherein the scene scenario further includes a time synchronization value, and in the executing step, the scene scenario is interpreted in a time-series manner by referring to the time synchronization value to be executed.

6. The method for automating a scene-based test according to claim 1, wherein the event object includes a component identification value for generating an event and a kind of the event, and the event signal includes the component identification value for generating the event and the kind of the event.

7. The method for automating a scene-based test according to claim 1, wherein the program execution log includes execution scene data on which the program to be tested is executed on the testing target device, and in the result generating step, the execution scene data received from the testing target device and the program scene being currently executed in the scene scenario are compared with each other to generate the test result.

8. (canceled)

9. A system for automating a scene-based test, the system comprising:
a communication unit that is linked to a testing target device via communication;
a scene scenario managing unit that stores a scene scenario including at least two or more program scenes and event objects;
a test executing unit that analyzes the scene scenario in a time-series manner to execute the scene scenario, and transmits an event signal corresponding to the event object to the testing target device through the communication unit when the event object is executed; and
a test analyzing unit that receives a program execution log from the testing target device to generate a test result,
wherein the test executing unit further emphasizes the program scene being currently executed or the event object in the scene scenario displayed to the outside through a display unit,
wherein the scene scenario comprises the image constituting a screen of a testing target device on which a program to be tested is executed or a set of the images,
and wherein the event object comprises an expression object expressed by schematizing an event progressing scenario by linking at least two or more program scenes.
